(19) United States
(12) Patent Application Publication
(10) Pub. No.: US 2026/0120975 A1
(43) Pub. Date: Apr. 30, 2026

(54) APPARATUS AND METHODS FOR A WATERPROOF BUTTON ON A CURVED SURFACE

(71) Applicant: Lotus Laboratories Inc., San Jose, CA (US)

(72) Inventors: Dhaval C. PATEL, San Jose, CA (US); Robert OLSON, Bend, OR (US)

(21) Appl. No.: 18/925,814

(22) Filed: Oct. 24, 2024

(51) Int. Cl. H01H 13/06; H01H 13/14

(52) U.S. Cl. CPC H01H 13/06; H01H 13/14; H01H 2215/00

(57) ABSTRACT

An apparatus includes an inner curved portion of a ring and an outer curved portion of the ring. The outer curved portion defines a gap. The apparatus includes at least one electronic component configured to remotely operate a device, the at least one electronic component disposed within the gap. The apparatus includes a switch assembly at least partially disposed within the gap. The switch assembly includes a switch operably coupled to the at least one electronic component, a button configured to engage the switch, the button having a surface concyclic with an outer surface of the outer curved portion when not engaged, and a sealing component between the button and the switch, the sealing component configured to allow the button to operate the switch and to prevent a substance from contacting the at least one electronic component when the outer curved portion contacts the substance.

### TECHNICAL FIELD

The present application relates sealing (e.g., waterproofing) switches on a curved surface.

### BACKGROUND

Substances, such as liquids, water, creams, gels, pastes, dust, etc., can be damaging to electronic components. However, certain systems that include electronic components may include a switch that may desire actuation in situations where the switch may be exposed to substances. Existing solutions for sealing can include compression dam solutions such as O-rings and other methods for creating a seal to prevent substances from contacting electronic components. However, the existing solutions are not feasible for curved surfaces (e.g., rings) where surfaces are curved and where there is minimal space for a dam.

Thus, there is a need for a sealing system that allows for a switch to be used on a curved surface that can seal out substances without increasing the bulk of the product.

### SUMMARY

In some embodiments, an apparatus includes an inner curved portion of a ring and an outer curved portion of the ring. The outer curved portion defines a gap. The apparatus includes at least one electronic component configured to remotely operate a device. The at least one electronic component is disposed within the gap. The apparatus includes a switch assembly at least partially disposed within the gap. The switch assembly includes a switch operably coupled to the at least one electronic component. The switch assembly includes a button configured to engage the switch. The button has a surface concyclic with an outer surface of the outer curved portion when not engaged. The switch assembly includes a sealing component between the button and the switch. The sealing component is configured to allow the button to operate the switch and to prevent a substance from contacting one or more of the at least one electronic component or the switch when the outer curved portion contacts the substance.

In some embodiments, an apparatus includes an inner portion formed of a first material and an outer portion formed of a second material. The outer portion defines a gap. The apparatus includes at least one electronic component configured to operate a device. The at least one electronic component is disposed in the gap. The apparatus includes a switch assembly at least partially disposed within the gap. The switch assembly includes a switch operably coupled to the at least one electronic component. The switch assembly includes a button configured to engage the switch. The button is substantially aligned at least partially with the outer portion when not engaged. The switch assembly includes a sealing component coupled to the outer portion and the inner portion and between the button and the switch. The sealing component is configured to allow the button to operate the switch and to prevent substance from contacting the at least one electronic component when the outer portion contacts the substance.

In some embodiments, an apparatus includes an inner portion and an outer portion. The outer portion defines a gap. The apparatus includes at least one electronic component configured to operate a device. The at least one electronic component is disposed in the gap. The apparatus includes a switch assembly at least partially disposed within in the gap. The switch assembly includes a switch operably coupled to the at least one electronic component. The switch assembly includes a button configured to engage the button, aligned at least partially with the outer portion when not engaged and hingedly operable about at least one notch defined by the inner portion. The switch assembly includes a sealing component coupled to the inner portion and the outer portion between the button and the switch, the sealing component configured to allow the button to operate the switch and to prevent a substance from contacting one or more of the at least one electronic component or the switch.

### BRIEF DESCRIPTION OF THE DRAWINGS

Reference should be made to the following detailed description which should be read in conjunction with the following figures, wherein like numerals represent like parts.

FIG. 1 is a schematic block diagram of a sealed switch system, according to an embodiment.

FIG. 2 is a perspective view of a sealed switch system, according to an embodiment.

FIG. 3 is a sectional view of the sealed switch system of FIG. 2 taken along a circumference, according to an embodiment.

FIG. 4 is a sectional view of the sealed switch system of FIG. 2 taken along a width of a ring, according to an embodiment.

FIGS. 5A-5B depict various views of a sealing component, according to embodiments.

FIGS. 6A-6B depict various view of a button, according to embodiments.

FIG. 7 depicts a sectional view of a linearly translating switch assembly of a sealed switch system taken along a circumference, according to embodiments.

FIG. 8 depicts a sectional view of a hinged switch assembly of a sealed switch system taken along a circumference, according to embodiments.

FIG. 9 depicts a flowchart of a method of operating a sealed switch system, according to embodiments.

### DETAILED DESCRIPTION

The present disclosure is not limited in its application to the details of construction and the arrangement of components set forth in the following description or illustrated in the drawings. The examples described herein may be capable of other embodiments and of being practiced or being carried out in various ways. Also, it may be appreciated that the phraseology and terminology used herein is for the purpose of description and should not be regarded as limiting as such may be understood by one of skill in the art. Throughout the present description, like reference characters may indicate like structure throughout the several views, and such structure need not be separately discussed. Furthermore, any particular feature(s) of a particular example embodiment may be equally applied to any other example embodiment(s) of this specification as suitable. In other words, features between the various example embodiments described herein are interchangeable, and not exclusive.

Some embodiments described herein relate to a sealed switch system (e.g., sealed switch ring, etc.) configured to prevent a substance (e.g., liquid, cream, gel, paste, sand, dust, powder, etc.) from contacting electronic components disposed within a housing while allowing a user to actuate a switch. The sealed switch system includes a sealing component that is configured to seal electronic components and a switch in a gap defined by a housing. The sealing component can include multiple materials of different flexibility that allows for a button to operate a switch through the sealing component while providing a barrier from substances. The sealing component can be configured to couple to materials of various types to form the seal and prevent substances from contacting the electronic components.

In some embodiments, the sealed switch system described herein can be implemented in a ring configured to be worn by a user. When worn, the sealed switch system can be operated by a user to operate one or more function associated with the ring. The sealing features of the sealed switch system allow for the user to wear the ring during situations where the ring may be exposed to liquid such as during hand washing. Furthermore, the low profile of the sealed switch system allows for the ring to be worn by the user without being undesirably impeding (e.g., large, bulky, etc.) or undesirably triggering.

The sealed switch system described herein can be used on a ring, or can be used in other systems, such as those with flat (e.g., linear) housing arrangements. The sealed switch system is configured to provide a protective layer for electronic component(s) by sealing curved surfaces without increasing bulk of the system.

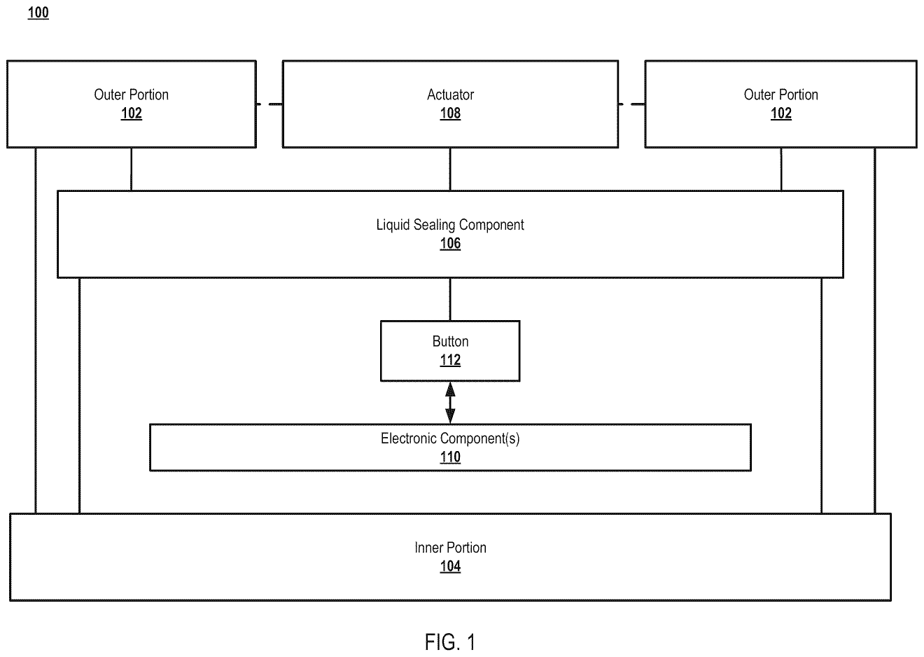

FIG. 1 is a schematic block diagram of a sealed switch system 100 (e.g., system 100), according to an embodiment. The system 100 is configured to form at least a portion of a device that a user is operating. For example, the system 100 can be a switch system on a ring. The system 100 is configured to allow a user to access and operate a switch 112 while preventing substances from coming into contact with electronics that may be damaged by substances. The system 100 can be used by a user to send a signal to a device when the switch 112 is operated. For example, the system 100 can be used to send a signal (e.g., infrared signal, radio signal, Wi-Fi signal, etc.) to a device on a wall switch (e.g., switch that control a light, fan, etc.), which can then actuate the wall switch in response to the infrared signal (e.g., to operate a light, fan, etc.). The system 100 includes an outer portion 102, an inner portion 104, a sealing component 106, a button 108, electronic component(s) 110, and a switch 112. In some embodiments, the button 108, the sealing component 106, and the switch 112 may be portions of and/or defined as a switch assembly. In some embodiments, the switch 112 may be a portion of the electronic component(s) 110.

The outer portion 102 and the inner portion 104 form at least a portion of a housing. The housing is configured to provide structure and/or house other components of the system 100. For example, the housing can form the shape of a wearable such as a ring, a bracelet, a watch, a necklace and/or the like. In some implementations, the outer portion 102 and the inner portion 104 are monolithically defined and/or constructed (e.g., form one structure). In some implementations, the outer portion 102 is an outer curved portion of a ring and the inner portion 104 is an inner curved portion of a ring. The outer portion 102 is as first portion of the housing. The outer portion 102 defines an outer shape of the housing (e.g., outer perimeter, outer surface, etc.). The outer portion 102 defines a gap between multiple portions of the outer portion 102 and/or in one contiguous outer portion 102. The gap may allow for one or more components of the system 100 to be accessed. For example, the switch assembly can be at least partially disposed within the gap. In some implementations, the outer portion 102 is formed of a metal (e.g., aluminum, stainless steel, etc.), plastic (e.g., polycarbonate, etc.), and/or the like. In some implementations, the wall thickness of the outer portion 102 is between about 0.15 mm and about 1.5 mm, inclusive of all ranges and values therebetween. In some implementations, the wall thickness is about 0.5 mm. In some implementations, the wall thickness can be associated with ring size. For example, a larger ring size can include larger wall thicknesses. In some implementations, the outer portion 102 can include one or more features (e.g., notch, extrusion, tab, slot, etc.) configured to align one or more components of the system 100.

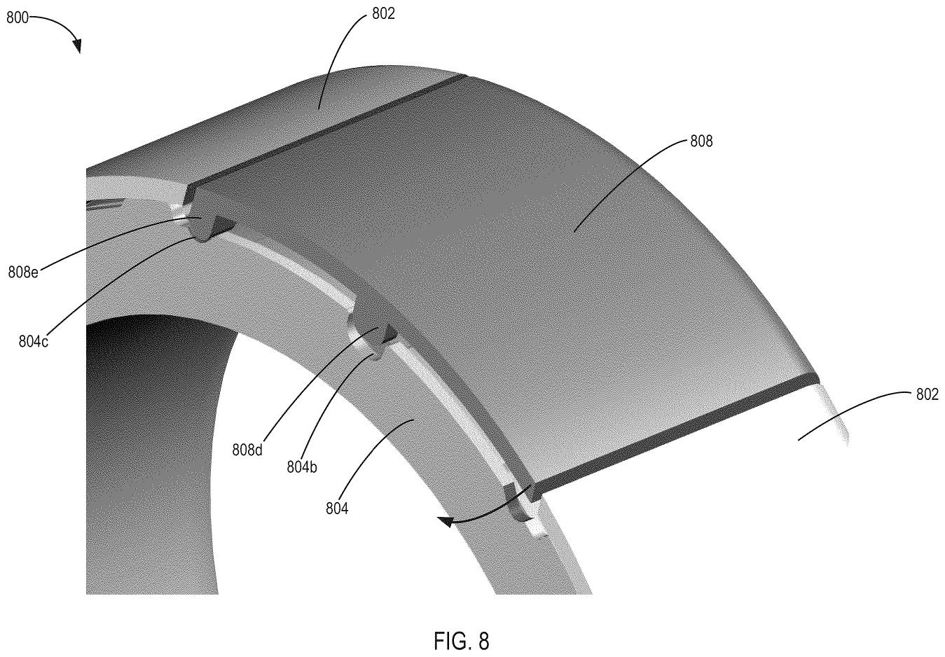

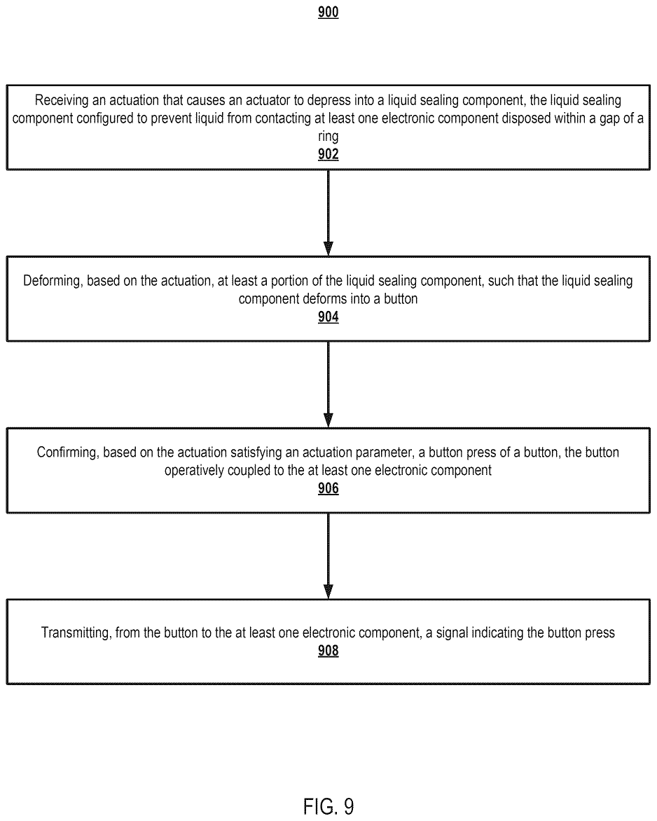

The inner portion 104 is a second portion of the housing. The inner portion 104 defines an inner shape of the housing (e.g., inner perimeter). In some implementations, the inner portion 104 can include sidewalls that extend away from the inner portion 104. In some implementations, the inner portion 104 is formed of a metal (e.g., aluminum, stainless steel, etc.), plastic (e.g., polycarbonate, etc.), and/or the like. In some implementations, the wall thickness of the inner portion 104 is between about 0.15 mm and about 2 mm, inclusive of all ranges and values therebetween. In some implementations, the wall thickness is greater than 2 mm. In some implementations, the wall thickness is about 0.8 mm thick. In some embodiments, the wall thickness is associated with a form factor of the inner portion 104. In some implementations, the outer portion 102 is formed of a different material than the inner portion 104. In some implementations, the inner portion 104 can include one or more features (e.g., notch, extrusion, tab, slot, etc.) configured to align one or more component of the system 100. For example, the inner portion 104 can include one or more notch configured to guide one or more component assembly in a desired movement. Examples of an inner portion with guiding notches are shown in FIGS. 8-9. In some implementations, the outer portion 102 is formed of the same material as the inner portion 104. In some implementations, the outer portion 102 can be monolithically formed (e.g., formed as a single portion) with the inner portion 104.

In some implementations, the inner portion 104 and/or the outer portion 102 can define a cavity. For example, the cavity can be defined as the shaped between the inner portion 104 and the outer portion 102. The cavity can be configured to house one or more components of the system 100, such as portions of the switch assembly, the electronic component(s) 110 and/or the like.

The electronic component(s) 110 include components configured to execute the desired function of the system 100. For example, the electronic component(s) 110 can be configured to perform a function (e.g., generate a signal, generate an action, transmit a signal, collect data, etc.) based on an input from a user, such as an actuation of the switch assembly. For example, the electronic component(s) 110 can be configured to, when actuated send a signal (e.g., infrared signal, radio signal, Wi-Fi signal, etc.) that is configured operate one or more function of a device (e.g., wall switch, light switch, fan switch, appliance switch, alarm system, radio, electrical outlet, television, blinds, curtains, drapes, doors, etc.). The electronic component(s) 110 can be configured to be housed in the cavity between the outer portion 102 and/or the inner portion 104. The electronic component(s) 110 can be operably coupled to the switch 112 via wires, flexible printed circuits (FPCs), printed circuit boards (PCBs), conductive ink, and/or the like. In some implementations, the electronic component(s) 110 can include a power source for operating the system 100, such as a battery (not shown in FIG. 1). In some implementations, it may be undesirable for the electronic component(s) 110 to come into contact with liquid (e.g., water, etc.), a cream, dust, a gel, sand, a powder (e.g., sugar, flour, etc.) to decrease the likelihood of damage. In some implementations, the electronic component(s) 110 can include a secondary seal and/or the like to provide redundant sealing.

The switch 112 is configured to, when actuated, send an actuation signal to the electronic component(s) 110. The switch 112 can be actuated when the switch 112 is depressed a desired distance (e.g., distance threshold). The switch 112 may be housed in the cavity defined between the outer portion 102 and the inner portion 104. In some implementations, the system 100 includes one switch 112. In some implementations, the system 100 can include additional switches. For example, the system 100 can include multiple switches that are associated with different functions. In some implementations, the system 100 can include a switch that can provide various signals depends on how it is actuated. For example, the switch can operate similar to a joystick where different directions can be associated with different signals. In some implementations, the switch 112 is actuated in response to an actuation parameter being satisfied. The actuation parameter can be a threshold pressing distance (e.g., actuated when the switch 112 is depressed a predetermined distance), a threshold pressing force (e.g., actuated when the switch 112 is depressed with a predetermined force), a threshold pressing pressure (e.g., actuated when the switch 112 is depressed with a predetermined pressure), a threshold pressing time (e.g., actuated when the switch 112 is depressed for a predetermined duration of time), a threshold pressing distance in a particular direction (e.g. actuated when the switch 112 is depressed a predetermined distance in a given direction) and/or the like.

The sealing component 106 is configured to prevent substances from contacting the electronic component(s) 110. For example, the substances can include liquids, creams, gels, sand, powder, dust, and/or other substances that can damage the electronic component(s) 110. In some embodiments, the sealing component 106 does not seal the electronic component(s) 110 from gas. The sealing component 106 is configured to span the gap defined by the outer portion 102 to provide a barrier between substance that enters the gap and portions of the cavity defined by the inner portion 104 and the outer portion 102. The sealing component 106 is coupled to the outer portion 102 and the inner portion 104. In some implementations, the sealing component 106 is coupled via an adhesive (e.g., liquid dispense adhesive, pressure sensitive adhesive, cyanoacrylate, pressure sensitive tape, etc.). In some implementations, the adhesive can be used in small form factors and does not substantially increase the bulk of the system 100. In some implementations, the sealing component 106 can be coupled to the inner portion 104 and the outer portion 102 via other types of coupling (e.g., fasteners, welding, compression, etc.). In some implementations, using an adhesive is desirable as an adhesive reduces or eliminates induced stress on the components of the inner portion 104, the outer portion 104, and/or the sealing component 106. With induced stress reduced or eliminated, the inner portion 102, the outer portion 104, and/or the sealing component 106 can be thinner to resist deformation during use (e.g., does not introduce additional bulk). Using an adhesive also allows for further flexibility in how surfaces can be coupled, unlike in a compression fitting, as adhesive contact points can be of variable sizes with varying dimensions. Using an adhesive also allows for movement in any direction in addition to the radial direction.

The sealing component 106 can include a first portion and a second portion. The first portion of the sealing component 106 can be configured to couple to the inner portion 104 and the outer portion 102 and is substantially stiff providing a first flexibility. In some implementations, the first portion is formed of a plastic. The second portion can be configured to elastically deform under pressure allowing for force to be transferred across the second portion, while preventing substances from breaching the sealing component 106. The second portion is elastically deformable and provides a second flexibility. In some implementations, the second flexibility is greater than the first flexibility. In some implementations, the second portion can be selectively deformable (e.g., elastically deformable) between an undeformed configuration and a deformed configuration. In the undeformed configuration, the second portion is substantially flat and is not receiving any pressing forces. In the deformed position, the second portion is receiving a pressing force that causes the second portion to deform. In some implementations, the amount of deformation is associated with the pressing force. When the pressing force is removed, the second portion is configured to return to the undeformed configuration. Similarly stated, the second portion is biased in the undeformed configuration. In some implementations, the second portion is formed of an elastomer. In some implementations, the first portion and the second portion are co-molded. In some implementations, the sealing component 106 can include one or more features (e.g., extrusion, recesses, grooves, etc.) configured to allow for other components of the system 100 to fit in the cavity. For example, the sealing component 106 can include recesses that are configured to define space in which the electronic component(s) 110 are disposed.

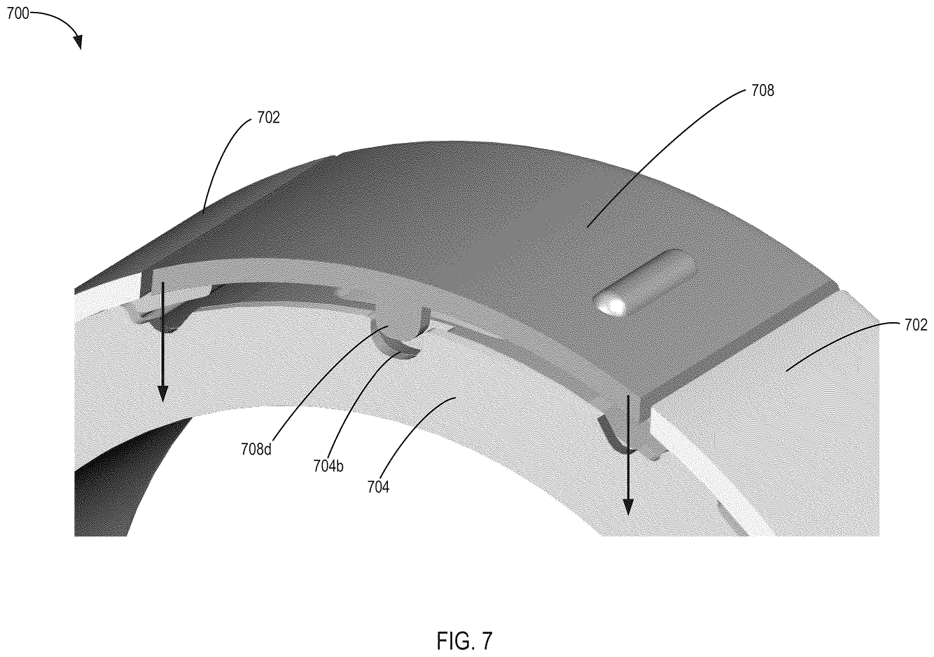

The button 108 is a portion of the switch assembly configured to be operated by a user to actuate the switch 112. The button 108 is configured to be at least partially disposed within the gap defined by the outer portion 102. In some implementations, the button 108 can include at least one protrusion configured to prevent the button 108 from being pulled out of the gap when not desired. The button 108 defines a bump that is configured to engage the sealing component 106 when the button 108 is depressed. The bump is configured to engage the second portion, such that the second portion plastically deforms into the switch 112 and actuates the switch. In some implementations, the button 108 can include one or more protrusions configured to engage one or more notch in the inner portion 104, which guide the button 108 in a desired motion. For example, the button 108 may be configured to linearly depress, such as shown and described in reference to FIG. 7, or can be hinged, such as shown and described in reference to FIG. 8. In some implementations, the button 108 can include one or more features, such as a bump, a depression, a groove, a symbol, and/or the like that can provide tactile feedback to a user. the tactile feedback can allow for a user to find the button 108 on the system 100 without looking and based on feel. In some implementations, the button 108 may be replaceable based on desired tactile features and/or the like.

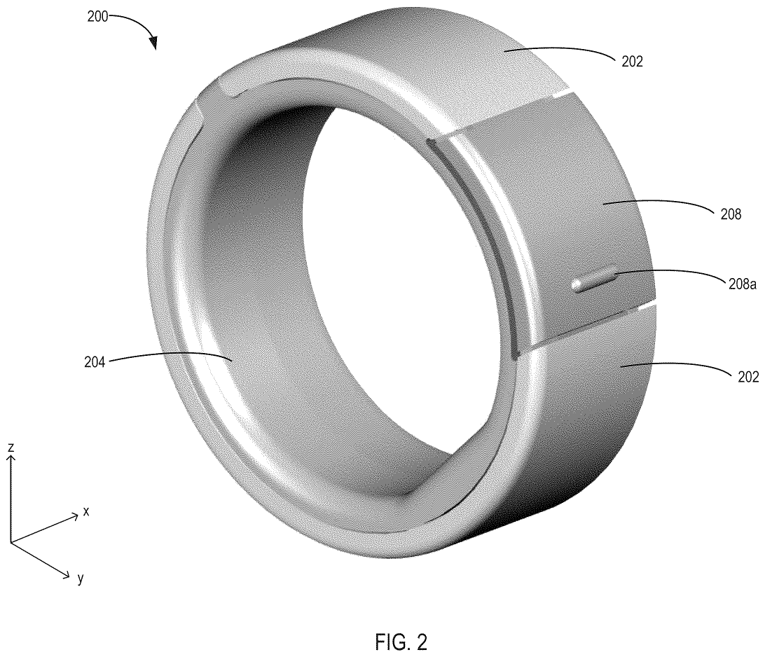

Referring generally to FIGS. 2-4, a sealed switch system 200 (also referred to as the system 200) (e.g., structurally and/or functionally similar to the system 100 of FIG. 1) is shown. The system 200 is configured as a ring that is intended to be worn on a finger of a user. While worn on the finger, a user can actuate the system 200 to activate one or more desired function of the system 200. The system 200 is configured to be operable in conditions where the system 200 may be immersed in or contacting a liquid, such as when the user is hand washing. The system 200 is configured to protect electronics from the substances by sealing out substances from undesired portions of the system 200. The system 200 includes an outer portion 202 (e.g., structurally and/or functionally similar to the outer portion 102 of FIG. 1), an inner portion 204 (e.g., structurally and/or functionally similar to the inner portion 104 of FIG. 1), a sealing component 206 (e.g., structurally and/or functionally similar to the sealing component 106 of FIG. 1), a button 208 (e.g., functionally and/or structurally similar to the button 108 of FIG. 1), electronic components 210 (e.g., functionally and/or structurally similar to the electronic components 110 of FIG. 1), and a switch 212 (e.g., functionally and/or structurally similar to the switch 112 of FIG. 1).

FIG. 2 is a perspective view of a sealed switch system 200, according to an embodiment. As seen in FIG. 2, the inner portion 204 defines an inner portion of a ring. The outer portion 202 defines an outer portion of the ring. The outer portion 202 defines a gap, in which the button 208 is partially disposed. During operation, the system 200 is worn such that a user depresses the button 208 to activate one or more desired functions associated with the system 200 (e.g., activates the electrical components in the system 200. The button 208 includes a tactile feature 208a, which in the system 200 is a bump. In some implementations, the button 208 can include no tactile feature 208a or can include another tactile feature such as a groove, a notch, an extrusion, a pattern, and/or any feature that a user can use to, by feel, identify the button 208. In some implementations, the location of the tactile feature 208a can be variable. For example, the location of the tactile feature 208a can be changed based on if the ring is worn on the left hand or the right hand, which finger the ring is worn on, and/or the like.

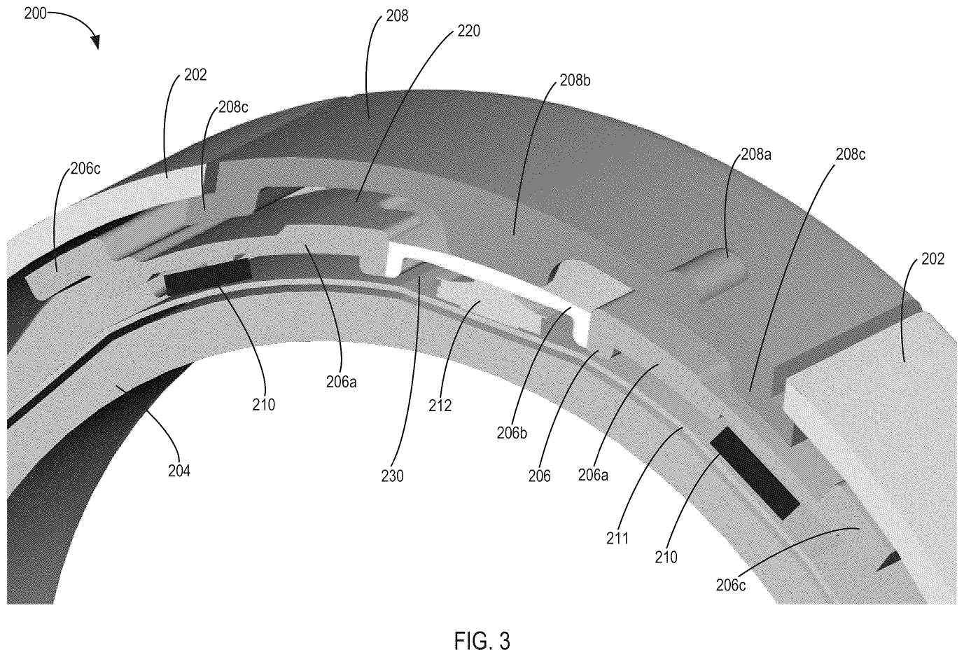

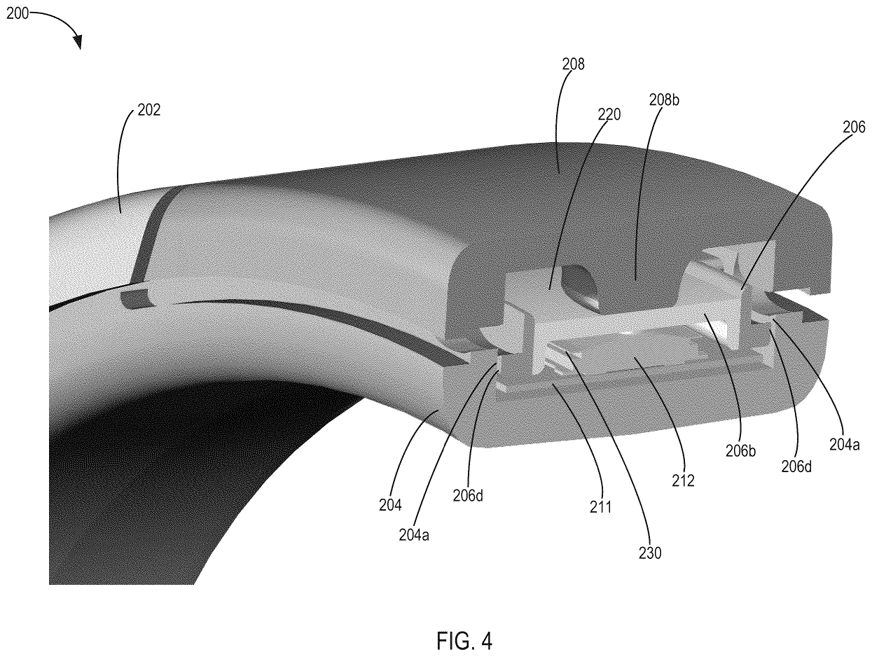

FIGS. 3-4 are cross-sectional views of the portion the sealed switch system 200 of FIG. 2 that include a switch assembly. The cross-sectional view of FIG. 3 is taken along the y-z plane as seen in FIG. 2. The cross-sectional view of FIG. 4 is taken along the x-z plane as seen in FIG. 2. As seen in FIG. 4, the inner portion 204 is formed in a U-shape that includes sidewalls 204a that define a channel. The outer portion 202 and the inner portion 204 together define a cavity. The electronic components 210, the switch 212, and the sealing component 206 are disposed within the cavity. The button 208 is at least partially disposed within the cavity and defines an outer surface of the cavity within a gap defined by the outer portion 202. The electronic component(s) 210 and the switch 212 are disposed within the cavity and are coupled together by a printed circuit 211. In some implementations, a stiffener can be disposed along the inner portion 204 to stiffen the ring.

The cavity is split into a sealed portion 230 (e.g., portion where a substance is prevented from entering) and an unsealed portion 220 (e.g., portion that may contact liquid) by the sealing component 206. The sealing component 206 includes a first portion 206a and a second portion 206b. The first portion 206a defines coupling tabs 206c. The first portion 206a further defines a side surface 206d (shown in FIG. 4) that is substantially flat and/or engages with a complementary shape of sidewalls 204a of the inner portion 204. The sealing component 206 is curved to substantially match the curvature (e.g., be parallel with) of the inner portion 204 and the outer portion 202. The first portion 206a is a stiff material that provides the sealing component 206 with structure. The first portion 206a is coupled to the outer portion 202 via the coupling tabs 206c. In some implementations, the coupling tabs 206c are coupled to the outer portion 202 via an adhesive. Using adhesive allows for low-profile coupling. In some implementations, the coupling tabs 206c can be coupled to the outer portion 202 via a fastener, welding, heating, and/or the like. The coupling tabs 206c are shaped such that they engage a complementary portion and/or recess defined by the outer portion 202. The first portion 206a is coupled to the inner portion 204 via the side surface 206d. In some implementations, the side surface 206d is coupled to the inner portion 204 via an adhesive.

The sealing component 206 is coupled to the inner portion 204 and the outer portion 202 in such a way that the space radially inward from the sealing component 206 is sealed from outside substances (e.g., substances contacting an outer surface of the sealed switch system 200), thus protecting the switch 212 and the electronic components 210 from substances. Because the sealing component 206 is adhered to the inner portion 204 and the outer portion 202, the switch assembly is sealed from substances without the use of compression, which can cause complications and/or can use additional structure. The sealing component 206 also provides sealing between multiple different types of materials, when the outer portion 202 is a first material and the inner portion 204 is a second material different from the first material. The first portion 206a can include one or more recessed portions that provides space for the electronic components 210 to be disposed in the cavity between the inner portion 204 and the sealing component 206. The first portion 206a can additionally include a recessed portion on a top surface adjacent to the coupling tabs 206c that allow for the button 208 to be depressed a desired distance, as to allow for the switch 212 to be actuated.

Second portion 206b is a portion of the sealing component 206 that is contiguous with the first portion 206a but formed of a more flexible material (e.g., elastomer) than the first portion 206a. The location of the second portion 206b generally aligns with the location of the switch 212 so that the switch 212 can be actuated via an elastic deformation of the second portion 206b. In some implementations, the first portion 206a and the second portion 206b are co-molded as to prevent substances from penetrating the transition point between the first portion 206a and the second portion 206b. As seen in FIGS. 3-4, a thickness of the first portion 206a where the first portion 206a contacts the second portion 206b can be greater than a thickness of the first portion 206a elsewhere. Similarly, a thickness of the second portion 206b where the second portion 206b contacts the first portion 206a can be greater than a thickness of the second portion 206b elsewhere.

As seen in FIG. 3, the button 208 is a curved component that further includes a bump 208b and retention tabs 208c. As seen in FIG. 4, the outer surface of the button 208 is substantially aligned (e.g., concyclic) with at least a portion of the outer surface of the outer portion 202 when the button 208 is not depressed. A concyclic configuration of the outer surface of the button 208 and the outer surface of the outer portion 202 can include the button 208 outer surface being substantially parallel to a curve defined by the outer surface of the outer portion 202 and/or the outer surface of the button 208 completing, or partially completing, the gap defined by the outer portion 202. The button 208 is free floating and not coupled to another component which can allow for the button 208 to be removed or replaced, which can allow for different types of switches (e.g., different tactile feature, etc.) based on user preference. The retention tabs 208c are configured to prevent the button 208 from falling out of or being displaced from the gap defined by the outer portion 202. The retention tabs 208c extend away from a surface opposite the surface the user (e.g., inner surface) is configured to engage to fit under the outer portion 202. The bump 208b extends inward from the outer surface of the button 208. The bump 208b is configured, when the button 208 is depressed by a user, to engage the second portion 206b of the sealing component 206. Based on the pressing force from the bump 208b, the second portion 206b then depresses an associated distance toward the switch 212, thus actuating the switch 212. In some implementations, the switch 212 depresses when the switch 212 is depressed a predetermined distance (e.g., threshold distance).

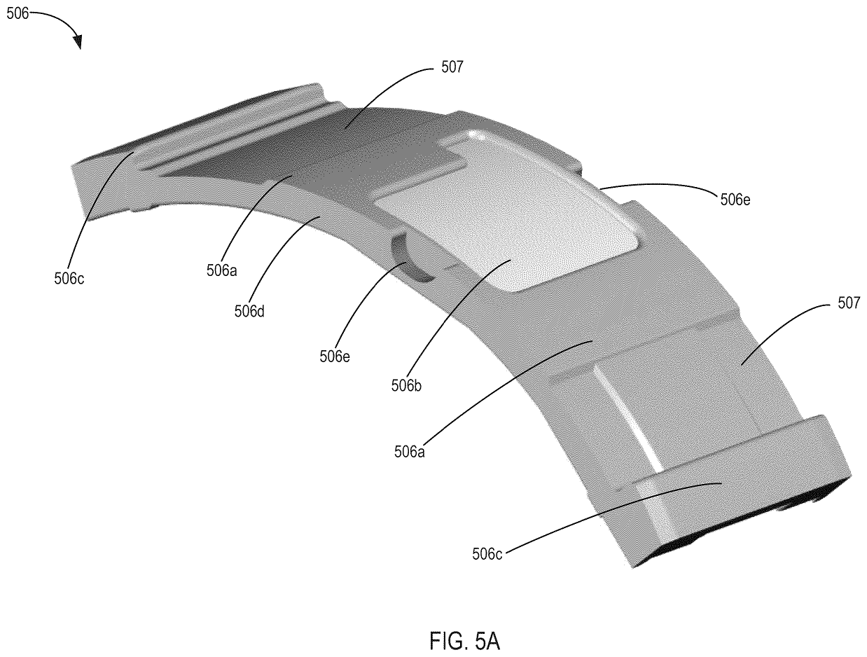

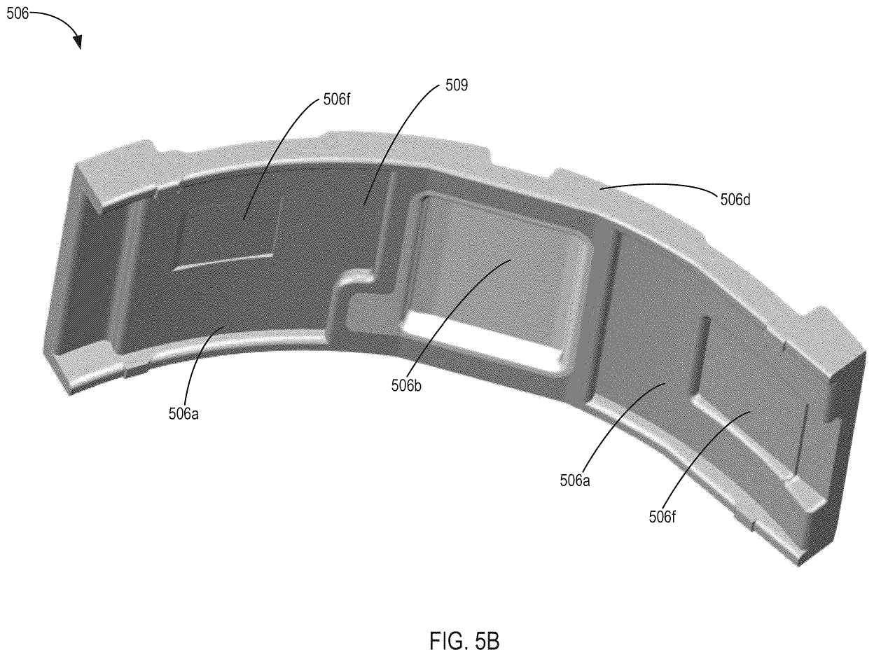

FIGS. 5A-5B depict various views of a sealing component 506 (e.g., functionally and/or structurally similar to the sealing component 106 of FIG. 1 and/or the sealing component 206 of FIGS. 3-4), according to an embodiment. The sealing component 506, similar to the other sealing components described herein, is configured to form a seal with one or more curved surfaces to prevent substances from penetrating to a desired location (e.g., a cavity containing electronics). The sealing component 506 defines a first portion 506a (e.g., functionally and/or structurally similar to the first portion 206a of FIGS. 3-4) and a second portion 506b (e.g., functionally and/or structurally similar to the second portion 206a of FIGS. 3-4). The first portion 506a includes coupling tabs 506c (e.g., functionally and/or structurally similar to the coupling tabs 206c of FIG. 3), a side surface 506d (e.g., functionally and/or structurally similar to the side surface 206d of FIGS. 3-4), notches 506e, and recesses 506f. The first portion 506a is curved as to match a curvature and/or contour of (e.g., be parallel to) an associated portion of the system where sealing is desired.

The coupling tabs 506c are portions of the first portion 506a that extend radially outward from the center of the first portion 506a. Similarly stated, the coupling tabs 506c are end portions of the first portion 506a. The coupling tabs 506c extend away as to provide a space for a button, such as any of the buttons described herein, to be depressed. In some implementations, the first portion 506a can define one or more recesses 507 into which the button can be depressed.

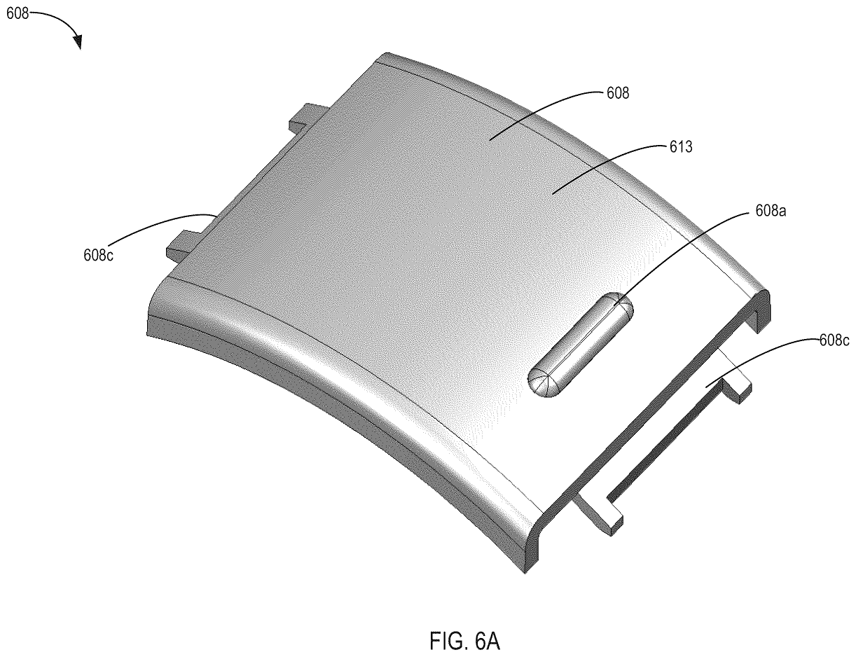

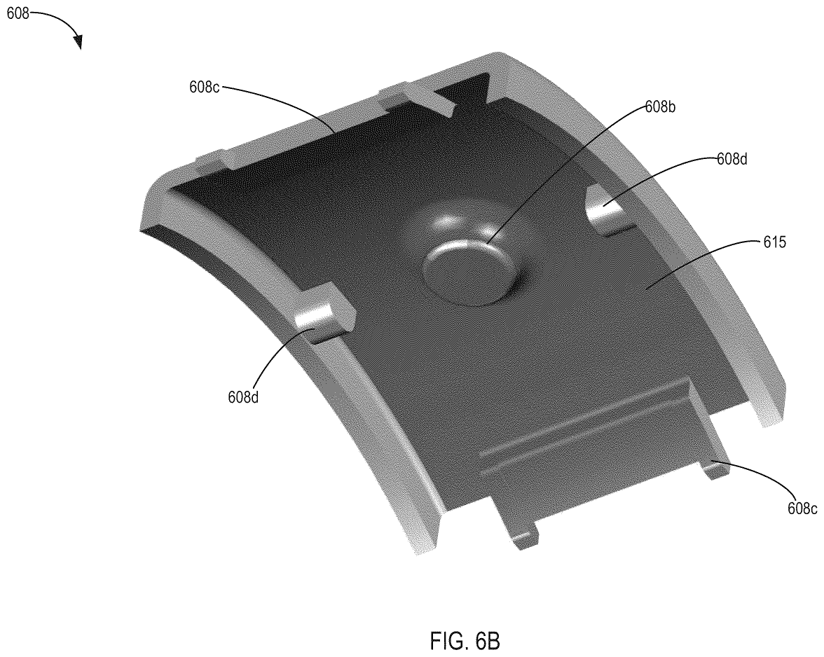

The side surface 506d is a surface along the sides of the sealing component 506 that provides for a coupling surface for the sealing component 506 to couple to a desired target, such as the inner portions described herein. The notches 506e are indentations on the side surface 506d of the first portion 506a that are configured to receive a complementary protrusion of the button, as seen and described in reference to FIGS. 6A-7. The notches 506e are located substantially centered along the sides of the sealing component 506. In some implementations, the sealing component 506 can include no notches 506e, additional notches 506e, and/or different types/orientations of notches 506e, depending on the button and the desired motion of the button. The bottom surface 509 of the sealing component 506, as seen in FIG. 5B defines additional recesses 506f. The recesses 506f provide locations for the electronic component(s) described herein to be disposed, as to decrease the overall height of the system when assembled.

FIGS. 6A-6B depict various views of a button 608 (e.g., functionally and/or structurally similar to the button 108 of FIG. 1 and/or the button 208 of FIGS. 2-4), according to an embodiment. As described above in reference to other buttons, the button 608 is configured to be depressed during operation of a switch assembly. The button 608 defines a tactile feature 608a (e.g., functionally and/or structurally similar to the tactile feature 208a of FIGS. 2-3), a bump 608b (e.g., functionally and/or structurally similar to the bump 208b of FIGS. 3-4), retention tabs 608c (e.g., functionally and/or structurally similar to the retention tabs 208c of FIG. 3), and protrusions 608d.

The button 608 is substantially curved as to substantially match the curvature and/or contour of (e.g., be parallel to) an outer portion, as described above. The tactile feature 608a extends away from a top surface 613 (e.g., radially outward) of the button 608 and is configured to provide tactile feedback to a user. In some implementations, the tactile feature 608a can be located in a different location, can be a different shape/size, and/or can be an indentation instead of a protrusion. In some implementations, the button 608 can include more than one tactile feature 608a. The bump 608b extends away from the bottom surface 615 (e.g., radially inward) of the button 608. The bump 608b extends a predetermined distance that is configured to operably engage and actuate a switch when the button 608 is depressed in an inward manner (e.g., towards an inner portion of a sealed switch system).

The retention tabs 608c and the protrusions 608d are configured to maintain a desired portion of the button 608 during operation. The retention tabs 608c extends away from the bottom surface 615 of the button 608 and are configured to prevent the button 608 from dislodging during operation or during a standby mode. In some implementations, such as the embodiment depicted in FIG. 6B, the retention tabs 608c can include prongs configured to engage associated receiving portions for aligning the button 608 during operation. The protrusions 608d of the button 608 that are configured to be received by a complementary portion of another component as to guide the button 608 during actuation. In some implementations, the protrusions 608d can be a predetermined height so that the button can be depressed a predetermined distance as to actuate but not damage a switch. A protrusion 608d engaging a complementary portion can be seen in and described in reference to FIG. 7.

FIG. 7 depicts a sectional view of a linearly translating switch assembly of a sealed switch system 700 (e.g., functionally and/or structurally similar to the system 100 of FIG. 1 and/or the system 200 of FIGS. 2-4) taken along a circumference, according to embodiments. The system 700 includes an outer portion 702 (e.g., structurally and/or functionally similar to the outer portion 102 of FIG. 1 and/or the outer portion 202 of FIGS. 2-4), an inner portion 704 (e.g., functionally and/or structurally similar to the inner portion 104 of FIG. 1 and/or the inner portion 204 of FIGS. 2-4), and a button 708 (e.g., functionally and/or structurally similar to the button 108 of FIG. 1, the button 208 of FIGS. 2-4, and/or the button 608 of FIGS. 6A-6B). The button 708 is configured to, in a first configuration (e.g., rest position) as shown in FIG. 7, have an outer surface substantially aligned and/or concyclic with the outer surface of the outer portion 702. In a second configuration (e.g., operating configuration), the button 708 is configured to be pressed radially inward so that the entirety of the button 708 linearly translated inward, as indicated by the arrows.

The button 708 defines a protrusion 708d (e.g., functionally and/or structurally similar to the protrusions 608d of FIG. 6B). The protrusion 708d is configured to engage a complementary notch 704b defined by a side portion of the inner portion 704. The notch 704b is an indentation that is configured to receive the protrusion 708d so that the button 708, when depressed, can be guided into the button, as described above. In some implementations, the notch 704b is configured to prevent the button 708 from undesired rotation and/or translation. In some implementations, the notch 704b is configured to provide a stop so that the button 708 is prevented from being depressed more than a predetermined distance. In some implementations, the predetermined distance may be configured to prevent damage to the switch.

FIG. 8 depicts a sectional view of a hinged switch assembly of a sealed switch system 800 (e.g., functionally and/or structurally similar to the system 100 of FIG. 1 and/or the system 200 of FIGS. 2-4) taken along a circumference, according to embodiments. The system 800 includes an outer portion 802 (e.g., structurally and/or functionally similar to the outer portion 102 of FIG. 1 and/or the outer portion 202 of FIGS. 2-4), an inner portion 804 (e.g., functionally and/or structurally similar to the inner portion 104 of FIG. 1 and/or the inner portion 204 of FIGS. 2-4), and a button 808 (e.g., functionally and/or structurally similar to the button 108 of FIG. 1, the button 208 of FIGS. 2-4, and/or the button 608 of FIGS. 6A-6B).

Similar to the button 708 as described in reference to FIG. 7, the button 808 defines a protrusion 808d (e.g., functionally and/or structurally similar to the protrusions 608d of FIG. 6B and/or the protrusion 708d of FIG. 7) configured to engage a complementary notch 804b defined by the inner portion 804. In the embodiment of FIG. 8, the button 808 defines a hinge protrusion 808e. The hinge protrusion 808e is configured to engage a complementary hinge notch 804c defined by the inner portion 804. The hinge protrusion 808e engages the hinge notch 804c such that the hinge notch 804c limits the button 808 to rotating about the hinge notch 804c so that the button 808 hingedly operates about the hinge notch 804c. During operation, when the button 808 is depressed, the button 808 rotates about the hinge notch 804c such that the button can engage a button, as described above. Specifically, the button 808 is configured to be actuated from a first configuration (e.g., rest position) to a second configuration (e.g., actuated position). In the first position, the button 808 has an outer surface substantially aligned and/or concyclic with the outer surface of the outer portion 802. In the second configuration, the end of the button 808 opposite the hinge protrusion 808e is configured to rotate inward about the hinge protrusion 808e, as indicated by the arrow.

FIG. 9 depicts a flowchart of a method 900 of operating a sealed switch system (e.g., functionally and/or structurally similar to the system 100 of FIG. 1, the system 200 of FIGS. 2-4, the system 700 of FIG. 7, and/or the system 800 of FIG. 8), according to an embodiment. In some implementations, the method 900 can be when a user operates a ring-based sealed switch system. For example, the method 900 can be used when a user operates the sealed switch system to actuate one or more desired functions of the ring. The method 900 includes receiving an actuation that causes a button (e.g., functionally and/or structurally similar to the button 108 of FIG. 1, the button 208 of FIGS. 2-4, the button 608 of FIGS. 6A-6B, the button 708 of FIG. 7, and/or the button 808 of FIG. 8) to depress into a sealing component (e.g., structurally and/or functionally similar to the sealing component 106 of FIG. 1, the sealing component 206 of FIGS. 3-4, and/or the sealing component 506 of FIGS. 5A-5B), the sealing component configured to prevent undesired substances from contacting at least one electronic component (e.g., structurally and/or functionally similar to the electronic component(s) 110 of FIG. 1 and/or the electronic components 210 of FIG. 3) and/or the switch disposed within a gap of a ring, at 902; deforming, based on the actuation, at least a portion of the sealing component, such that the sealing component deforms into a switch (e.g., functionally and/or structurally similar to the switch 112 of FIG. 1 and/or the switch 212 of FIGS. 3-4), at 904; confirming, based on the actuation satisfying an actuation parameter, a switch press of a button, the switch operatively coupled to the at least one electronic component, at 906; and transmitting, from the switch to the at least one electronic component, a signal indicating the switch press, at 908.

At 902, the method 900 includes receiving an actuation that causes a button to depress into a sealing component. The sealing component is configured to prevent substances from contacting at least one electronic component and/or the switch disposed within a gap of a ring. In some implementations, the actuation can include a user pressing the button. In some implementations, the button is configured to engage a portion of the sealing component that is elastically deformable. In some implementations, at least a portion of the ring is configured to guide the button such that the button engages the sealing component in a desired location.

At 904, the method 900 includes deforming, based on the actuation, at least a portion of the sealing component, such that the sealing component deforms into a switch (e.g., a deformed configuration). In some implementations, when the button is no longer depressed, the portion of the sealing component is configured to return to an undeformed configuration. In some implementations, the portion of the sealing component allows for an actuation force to be transferred from the button to the switch without compromising the sealing capabilities of the sealing component.

At 906, the method 900 includes confirming, based on the actuation satisfying an actuation parameter, a switch press of a button, the switch operatively coupled to the at least one electronic component. In some implementations, the actuation parameter includes at least one of a minimum actuation force, a minimum actuation distance, and/or the like. For example, the actuation satisfying the actuation parameter can include the switch being pressed at least the minimum actuation distance (e.g., actuation threshold) to actuate and/or engage the switch. In some implementations, if the actuation parameter is not satisfied, the method 900 stops and no subsequent action occurs. At 908, the method 900 includes transmitting, from the switch to the at least one electronic component, a signal indicating the switch press. In some implementations, the transmission may occur via an FPC, a PCB, wires, and/or the like. The method 900 can repeat whenever an actuation is received by the button. For example, whenever a user presses the button, the method 900 can repeat.

In some embodiments, an apparatus includes an inner curved portion of a ring and an outer curved portion of the ring. The outer curved portion defines a gap. The apparatus includes at least one electronic component configured to remotely operate a device, the at least one electronic component disposed within the gap. The apparatus includes a switch assembly at least partially disposed within the gap. The switch assembly includes a switch operably coupled to the at least one electronic component, a button configured to engage the switch, the button having a surface concyclic with an outer surface of the outer curved portion when not engaged, and a sealing component between the button and the switch. The sealing component is configured to allow the button to operate the switch and to prevent a substance from contacting one or more of the at least one electronic component or the switch when the outer curved portion contacts the substance.

In some implementations, the sealing component includes a first portion with a first flexibility and a second portion with a second flexibility greater than the first flexibility.

In some implementations, the first portion is formed of plastic and the second portion is formed of silicone.

In some implementations, the first portion and the second portion are co-molded.

In some implementations, the second portion is configured to engage the switch when the second portion is depressed by the button.

In some implementations, the button is configured to hingedly operate about a notch of the inner curved portion.

In some implementations, the button includes a tactile feature.

In some embodiments, an apparatus includes an inner portion formed of a first material and an outer portion formed of a second material. The outer portion defines a gap. The apparatus further includes at least one electronic component configured to operate a device, the at least one electronic component disposed in the gap, and a switch assembly at least partially disposed within the gap. The switch assembly includes a switch operably coupled to the at least one electronic component, a button configured to engage the switch, the button substantially aligned at least partially with the outer portion when not engaged, and a sealing component coupled to the outer portion and the inner portion and between the button and the switch, the sealing component configured to allow the button to operate the switch and to prevent a substance from contacting one or more of the at least one electronic component or the switch when the outer portion contacts the substance.

In some implementations, the sealing component is formed of a third material.

In some implementations, the first material is plastic, and the second material is metal.

In some implementations, the first material is polycarbonate.

In some implementations, the second material is at least one of aluminum or stainless steel.

In some implementations, the sealing component includes a first portion with a first flexibility and a second portion with a second flexibility greater than the first flexibility.

In some implementations, the first portion is formed of plastic and the second portion is formed of silicone.

In some embodiments, an apparatus includes an inner portion and an outer portion. The outer portion defines a gap. The apparatus includes at least one electronic component configured to operate a device. The at least one electronic component is disposed in the gap. The apparatus includes a switch assembly at least partially disposed within in the gap. The switch assembly includes a switch operably coupled to the at least one electronic component, an button configured to engage the switch, aligned at least partially with the outer portion when not engaged and hingedly operable about at least one notch defined by the inner portion, and a sealing component coupled to the inner portion and the outer portion between the button and the switch, the sealing component configured to allow the button to operate the switch and to prevent a substance from contacting one or more of the at least one electronic component or the switch.

In some implementations, the sealing component including a first portion with a first flexibility and a second portion with a second flexibility greater than the first flexibility.

In some implementations, the second portion is formed of an elastomer.

In some implementations, the sealing component is coupled to the inner portion and the outer portion by an adhesive.

In some implementations, the button removably engages the inner portion.

In some implementations, the button includes at least one tactile feature.

In some implementations, the substance is at least one of a liquid, a cream, dust, or a gel.

As used in this specification and the appended claims, the singular forms “a,” “an” and “the” include plural referents unless the context clearly dictates otherwise. Thus, for example, the term “a member” is intended to mean a single member or a combination of members, “a material” is intended to mean one or more materials, or a combination thereof.

As used herein, the terms “about” and/or “approximately” when used in conjunction with numerical values and/or ranges generally refer to those numerical values and/or ranges near to a recited numerical value and/or range. For example, in some instances, “about 40 [units]” can mean within ±25% of 40 (e.g., from 30 to 50). In some instances, the terms “about” and “approximately” can mean within ±10% of the recited value. In other instances, the terms “about” and “approximately” can mean within ±9%, ±8%, ±7%, ±6%, ±5%, ±4%, ±3%, ±2%, ±1%, less than ±1%, or any other value or range of values therein or therebelow. The terms “about” and “approximately” may be used interchangeably. Furthermore, although a numerical value modified by the term “about” or “approximately” can allow for and/or otherwise encompass a tolerance of the stated numerical value, it is not intended to exclude the exact numerical value stated.

In a similar manner, term “substantially” when used in connection with, for example, a geometric relationship, a numerical value, and/or a range is intended to convey that the geometric relationship (or the structures described thereby), the number, and/or the range so defined is nominally the recited geometric relationship, number, and/or range. For example, two structures described herein as being “substantially non-parallel” is intended to convey that, although a non-parallel geometric relationship is desirable, some parallelism can occur in a “substantially non-parallel” arrangement. Such tolerances can result from manufacturing tolerances, measurement tolerances, and/or other practical considerations (such as, for example, minute imperfections, age of a structure so defined, a pressure or a force exerted within a system, and/or the like). As described above, a suitable tolerance can be, for example, of ±1%, ±2%, ±3%, ±4%, ±5%, ±6%, ±7%, ±8%, ±9%, ±10%, or more of the stated geometric construction, numerical value, and/or range. Furthermore, although a numerical value modified by the term “substantially” can allow for and/or otherwise encompass a tolerance of the stated numerical value, it is not intended to exclude the exact numerical value stated.

The specific configurations of the various components described herein can also be varied. For example, the size and specific shape of the various components can be different from the embodiments shown, while still providing the functions as described herein. Additionally, the relative size of various components of the devices shown and described herein with respect to the size of other components of the devices are not necessarily to scale.

Similarly, where methods and/or events described above indicate certain events and/or procedures occurring in certain order, the ordering of certain events and/or procedures may be modified. While the embodiments have been particularly shown and described, it will be understood that various changes in form and details may be made.

What is claimed is:

1. An apparatus, comprising:
an inner curved portion of a ring;
an outer curved portion of the ring, the outer curved portion defining a gap;
at least one electronic component configured to remotely operate a device, the at least one electronic component disposed within the gap; and
a switch assembly at least partially disposed within the gap, the switch assembly including:
a switch operably coupled to the at least one electronic component;
a button configured to engage the button, the button having a surface concyclic with an outer surface of the outer curved portion when not engaged; and
a sealing component between the button and the switch, the sealing component configured to allow the button to operate the switch and to prevent a substance from contacting one or more of the at least one electronic component or the switch when the outer curved portion contacts the substance.

2. The apparatus of claim 1, wherein the sealing component includes a first portion with a first flexibility and a second portion with a second flexibility greater than the first flexibility.

3. The apparatus of claim 2, wherein the first portion is formed of plastic and the second portion is formed of silicone.

4. The apparatus of claim 2, wherein the first portion and the second portion are co-molded.

5. The apparatus of claim 2, wherein the second portion is configured to engage the switch when the second portion is depressed by the button.

6. The apparatus of claim 1, wherein the button is configured to hingedly operate about a notch of the inner curved portion.

7. The apparatus of claim 1, wherein the button includes a tactile feature.

8. An apparatus, comprising:
an inner portion formed of a first material;
an outer portion formed of a second material, the outer portion defining a gap;
at least one electronic component configured to operate a device, the at least one electronic component disposed in the gap; and
a switch assembly at least partially disposed within the gap, the switch assembly including:
a switch operably coupled to the at least one electronic component;
a button configured to engage the switch, the button substantially aligned at least partially with the outer portion when not engaged; and
a sealing component coupled to the outer portion and the inner portion and between the button and the switch, the sealing component configured to allow the button to operate the switch and to prevent a substance from contacting one or more of the at least one electronic component or the switch when the outer portion contacts the substance.

9. The apparatus of claim 8, wherein the sealing component is formed of a third material.

10. The apparatus of claim 8, wherein the first material is a plastic, and the second material is a metal.

11. The apparatus of claim 10, wherein the first material is polycarbonate.

12. The apparatus of claim 10, wherein the second material is at least one of aluminum or stainless steel.

13. The apparatus of claim 8, wherein the sealing component includes a first portion with a first flexibility and a second portion with a second flexibility greater than the first flexibility.

14. The apparatus of claim 13, wherein the first portion is formed of plastic and the second portion is formed of silicone.

15. An apparatus, comprising:
an inner portion;
an outer portion, the outer portion defining a gap;
at least one electronic component configured to operate a device, the at least one electronic component disposed in the gap; and
a switch assembly at least partially disposed within in the gap, the switch assembly including:
a switch operably coupled to the at least one electronic component;
a button configured to engage the switch, aligned at least partially with the outer portion when not engaged and hingedly operable about at least one notch defined by the inner portion; and
a sealing component coupled to the inner portion and the outer portion between the button and the switch, the sealing component configured to allow the button to operate the switch and to prevent a substance from contacting the one or more of the at least one electronic component or the switch.

16. The apparatus of claim 15, wherein the sealing component including a first portion with a first flexibility and a second portion with a second flexibility greater than the first flexibility.

17. The apparatus of claim 16, wherein the second portion is formed of an elastomer.

18. The apparatus of claim 15, wherein the sealing component is coupled to the inner portion and the outer portion by an adhesive.

19. The apparatus of claim 15, wherein the button removably engages the inner portion.

20. The apparatus of claim 15, wherein the button includes at least one tactile feature.

21. The apparatus of claim 15, wherein the substance is at least one of a liquid, a cream, dust, or a gel.
